(19) United States
(12) Patent Application Publication
(10) Pub. No.: US 2009/0214205 A1
(43) Pub. Date: Aug. 27, 2009

(54) COMMUNICATIONS AND DATA LINK JAMMER INCORPORATING FIBER-OPTIC DELAY LINE TECHNOLOGY

(75) Inventors: Patrick E. Clark, San Francisco, CA (US); Michael F. Lawler, Half Moon Bay, CA (US); John H. Russell, Gold River, CA (US)

Correspondence Address: KLEIN, O'NEILL & SINGH, LLP, 43 CORPORATE PARK, SUITE 204, IRVINE, CA, 92606, US

(73) Assignee: Sierra Nevada Corporation , a corporation

(21) Appl. No.: 12/096,174

(22) PCT Filed: Dec. 7, 2006
(86) PCT No.: PCT/US2006/061768

§ 371 Date: Sep. 18, 2008

Related U.S. Application Data
(60) Provisional application No. 60/748,093, filed on Dec. 7, 2005.

(51) Int. Cl. H04K 3/00

(52) U.S. Cl. 398/39

(57) ABSTRACT

A communications and data link jamming system employs a fiber-optic RF delay line to provide rapid responses to threat signals. A sample of the RF signal threat environment is stored within the delay line, and a jamming video signal is added to the stored sample by modulation as it is being extracted from the delay line. The extracted signal is re-circulated back into the delay line, thereby effectively stretching the sample for highly efficient jamming. The jamming system is effective in countering burst communications and in defeating multiple simultaneous threat signals.

This application claims the benefit, under 35 U.S.C. § 119(e), of co-pending Provisional Application No. 60/748,093, filed Dec. 7, 2005, the disclosure of which is incorporated herein by reference.

### FEDERALLY SPONSORED RESEARCH OR DEVELOPMENT

Not Applicable

### BACKGROUND OF THE INVENTION

1. Field of the Invention

This invention relates generally to electronic countermeasure systems. More specifically, the invention relates to a communications jamming system based on a Radio Frequency (RF) memory device using fiber-optic re-circulation technology.

2. Description of the Related Art

Modern military communication systems often employ short, burst type transmissions. These transmissions may occur at static frequencies or may constantly cycle through a secret sequence of frequencies in order to prevent detection and jamming. Typically, these systems only transmit on a particular frequency for at most a few milliseconds. Jamming such transmissions is often sought as a counter-measure, but the extremely short duration of such transmissions has made jamming difficult in practice.

The continuing development of modern military communication systems requires the ability to detect and counter enemy communications in a specified sector of a battlefield, no matter how short these transmissions are or how fast the communications change frequencies to avoid detection. Furthermore, since the duration of the target transmissions is so short, it is impractical to evaluate signals, make a determination, and then direct the transmission of a jamming. There is simply not enough time to engage these signals before they cease transmission or have moved on to a new frequency.

Conventional jamming systems attempt to solve this “short cycle” problem in one of two ways: (1) Barrage jamming, which involves “splashing” a segment of the radio frequency (RF) spectrum with random or distributed noise in order to jam frequency-hopping transmissions by brute force. Barrage jamming is impractical for several reasons, among them being the amount of power needed to apply sufficient RF energy to wash out all transmissions. (2) Responsive jamming, also called “fast-reaction” jamming, which requires the reception of signals and the automatic selective jamming of those signals soon thereafter, for as long as the enemy transmission is active. There are, in turn, two types of responsive jamming. The first type is “transponder” jamming, which uses a receiver to measure specific parameters of active signals that are necessary for constructing a jamming waveform. The second type is “follower” jamming, which captures or intercepts a sample of the active signals and applies a jamming modulation to this sample to create a jamming signal.

A typical conventional transponder jammer 100 is shown in FIG. 1. It includes an antenna 102, a transmit/receive (T/R) switch 104, a receiver 106, a controller 108, and an exciter 110. The transponder jammer 100 is programmed to intercept and respond to active signals from a potential target(s). During the signal detection period (or reception mode) of jammer operation, the controller 108 actuates the transmit/receive (T/R) 104 switch so as to allow external signals to enter the system through the antenna 102 for processing by the receiver 106. Typically, the receiver 106 scans an instantaneous bandwidth window 116, as shown in FIG. 1A, across the expected threat operating frequency range (“Expected Target Range” 117 in FIG. 1A).

Once a signal is detected, the controller 108 determines whether the signal should be disrupted or jammed. Following a positive determination, the controller 108 directs the exciter 110 to tune to the detected signal frequency and add a jamming waveform, such as noise, a continuous wave (CW) tone, or a swept tone. Then, the system 100 transmits the disruption or jamming signal, via the T/R Switch 104, through the antenna 102, and radiates it into the atmosphere.

The size of the instantaneous bandwidth is dependent upon the specific receiver technology used. For example, a common receiver architecture (not shown here) employs a hybrid configuration, including a super-heterodyne receiver that performs the scan operation, followed by a digital receiver that implements a Fast Fourier Transform (FFT). The digital receiver converts the analog signal to digital data and then performs an FFT, resulting in the identification of the frequency and power level of all active signals within the instantaneous bandwidth. The processing time 118 in FIG. 1A includes the time necessary to change the receiver's frequency and to sample and process the signals within this bandwidth.

There are several shortcomings associated with transponder type of jammer system. First, due to the scanning nature of the receiver, an undesirably long revisit time 119 may exist, as shown in FIG. 1A. This may result in a long response time relative to the duration of the threat signal. In many instances, involving short or burst messages, the threat transmit time may be so short that the transponder jammer's response will arrive after the threat has completed its transmission. Similarly, for a frequency hopping threat signal, the signal may change or “hop” to another frequency so quickly that the conventional jammer is unable to perform its internal processing and adjustment tasks before the threat signal moves to another frequency. A second problem is that if many potential threat signals are simultaneously present, the transponder jammer may not be able to disrupt all of them in an efficient manner. Finally, if the transponder jammer limits its receiver scan to only a limited number of frequencies identified from previous experience or intelligence-gathering operations as threats, when the threat evolves into a different frequency, the transponder jammer will fail.

An exemplary form of a conventional follower jamming system 100′, also known as a re-circulating follower, is shown in FIG. 2. The antenna assembly 102′ and T/R switch 104′ function as previously described for the transponder jamming system. The incoming signal that is intercepted by the antenna 102′ is routed through the T/R switch 104′, a first coupler 111a, and an amplifier 112. A portion of the signal is removed by a second coupler 111b and sent to a delay line 113 that acts as a storage medium. As the signal propagates thought the delay line 113, it is reintroduced into the RF path by the first coupler 111a. The amplifier 104′ compensates for the insertion losses associated with the couplers 111a, 111b and the delay line 113. As the signal loops or re-circulates around the coupler-amplifier-delay line structure, a portion propagates through the second coupler 111b. A jamming modulator 114 causes the signal to be modified in such a manner as to disrupt the threat communication link. A controller 108′ sets the timing and state of all switches in the system.

The conventional follower jamming system contains several drawbacks associated with the delay line implementation. Those systems that incorporate surface acoustic wave or bulk acoustic wave technologies suffer from limited instantaneous RF bandwidth, since these devices are inherently narrow band. Delay lines consisting of coaxial cable overcome bandwidth limitations but exhibit high insertion losses, thus limiting maximum storage times. Reduced storage time causes increased spectral spreading due to the phase discontinuity that nearly always exists as the signal re-circulates. Excessive spectral spreading reduces the concentration of jamming power on the threat signal, reducing jamming effectiveness.

Thus, there is a need in the communications jamming art for systems and techniques that effectively provide rapid wideband jamming effective against both short message threats and frequency hopping threats, as well as multiple simultaneous threats.

### SUMMARY OF THE INVENTION

The present invention overcomes the limitations of the prior art by using a wideband RF delay line. In a preferred embodiment, this delay line is a fiber-optic cable arranged to allow for recirculation of RF signals. In place of a conventional scanning receiver, the present invention provides instantaneous frequency coverage across the entire communications band of 20 MHz to over 2 GHz. Friendly or non-threat frequency ranges are excluded from processing. Fixed and tunable band-pass and band-reject filters are used during equipment setup to exclude these frequency ranges. All “active” signal samples (i.e., those that are not excluded by the filter assembly) are fed to a fiber-optic delay line (FODL) that stores an RF sample that is typically less than 1 millisecond in duration. The sample period is not adjustable and is determined by the length of fiber-optic cable. Once the sample is stored, RF switches within the jammer change the routing of the signal, so that external signals no longer enter the jammer. The contents of the FODL re-enter or re-circulate through the FODL a predetermined number of times, and then the FODL contents exit the FODL to combine with a jamming video waveform generated by a controller in the system. The combined signals are amplified and radiated into the environment. The re-circulation action continues for a defined number of re-circulations (e.g., ten to twenty) before a new RF sample is taken. Since the jamming signal is generated from an input sample, it does not require time-consuming scanning, frequency conversions, and analog-to-digital conversions or any digital computations. As a result, the jammer's response time is extremely short, thereby enabling the jammer to defeat short messages, as well as more complex communication systems, such as those employing frequency hopping transmissions. Furthermore, since all signals in the FODL are treated as threat signals, the jammer can defeat multiple simultaneous threats.

### BRIEF DESCRIPTION OF THE DRAWINGS

The foregoing features and other features of the present invention will now be described, with reference to the drawings of several preferred embodiments. In the drawings, the same components have the same reference numerals. The illustrated embodiments are intended to illustrate, but not to limit the invention. The drawings include the following figures:

FIG. 1 is a general block diagram of a conventional prior art transponder jammer;

FIG. 1A is a diagram illustrating the relationships associated with searching a range of frequencies and the time necessary to perform this activity, as it applies to the conventional prior art transponder jammer;

FIG. 2 is a general block diagram of a conventional prior art follower jammer;

FIG. 3 is a general block diagram of a jamming system using RF delay line technology, in accordance with a first preferred embodiment of the present invention;

FIGS. 4, 5, 6 and 7 are block diagrams of a front end assembly, a channel assembly, an AGC assembly and FODL assembly respectively;

FIG. 8 is a timing diagram showing a representative timing relationship between the sampling and jamming periods in the present invention;

FIG. 9 is a block diagram illustrating the switch configuration during the sampling mode in the operation of the present invention;

FIG. 10 is block diagram illustrating the switch configuration during the jamming mode in the operation of the present invention;

FIG. 11 is a block diagram illustrating a second preferred embodiment of the present invention, in which separate receiving and transmitting antennas are used; and

FIG. 12 is a block diagram illustration of a third preferred embodiment of the present invention, in which multiple high power amplifiers are used.

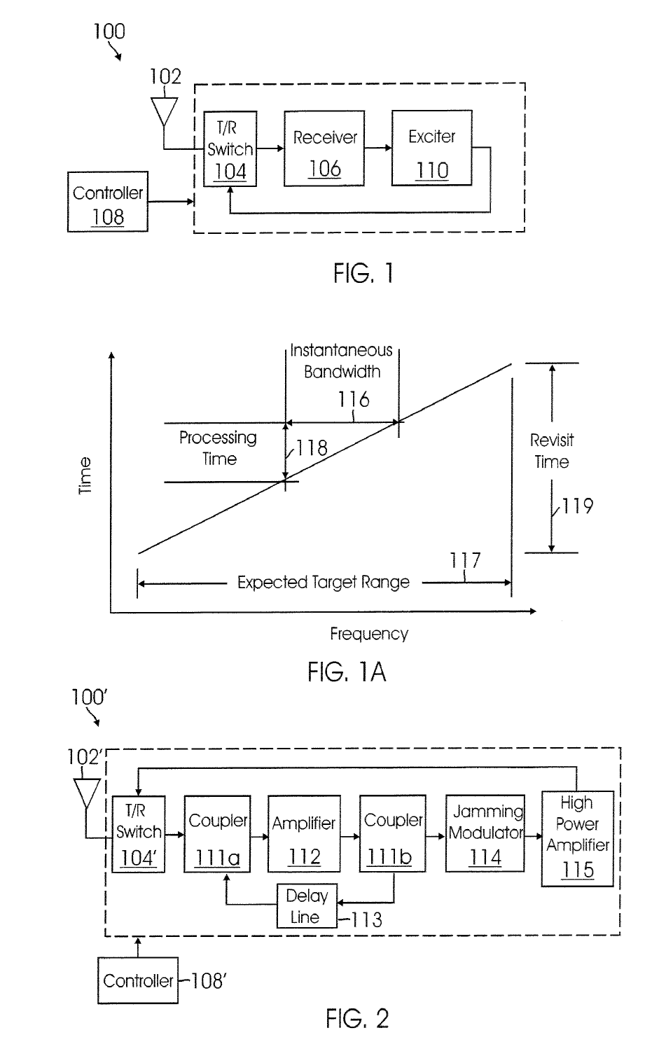

### DETAILED DESCRIPTION OF THE INVENTION

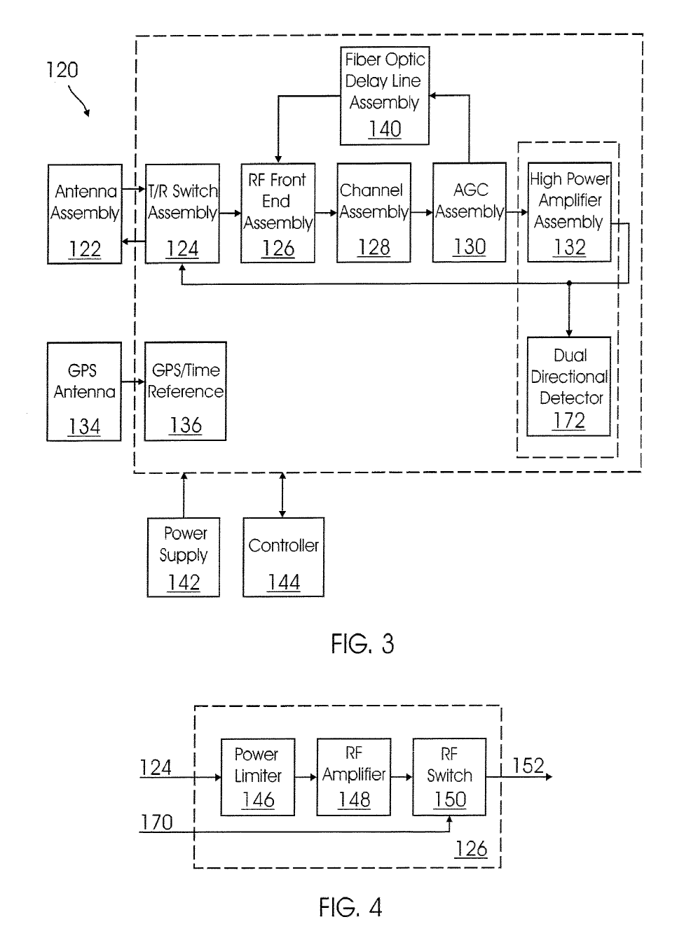

FIGS. 3, 4, 5, 6 and 7 are functional block diagrams of a communications jamming system 120, in accordance with a first preferred embodiment of the present invention. The system 120 includes an antenna assembly 122 comprising one or more antenna elements (not shown), depending upon the frequency range of operation in intercepting electromagnetic signals from the surrounding physical environment for input into the system. A T/R (Transmit/Receive) switch assembly 124 allows individual elements within the antenna assembly 122 selectively to function either as signal sensors or signal radiators. Timing circuits (not shown) within a controller 144 (to be described in more detail below) provide appropriate timing signals that direct the flow of RF energy into and out of the jamming system 120.

A power supply 142 provides operational power to the system. The particular type of power supply will depend on the specific application and the operational environment of the system. For a mobile vehicle installation, the power source 142 may be either 12V DC (commercial automobile or truck) or 24V DC (military vehicle). For a stationary installation, such as protection of a building, roadway, entrance ramp, etc., the power source 142 may be 110V AC, 220V AC or 440V AC. Finally, for a man-portable application, such as a backpack, an assembly of primary or secondary batteries (e.g., 6 to 48V DC) would be appropriate.

An RF front-end (RFFE) assembly 126 performs several important functions associated with signal processing prior to signal sample storage and re-circulation. These functions include the protection of internal electronic components against excessive RF power. As shown in FIG. 4, the RFFE 126 includes a power limiter 146 receiving the RF signal from the T/R switch 124, a signal amplifier 148 receiving the power-limited output of the power limiter 146, and a first RF switch 150 that receives the amplified signal from the amplifier 148 and a signal from a second RF power divider 170, to be discussed below.

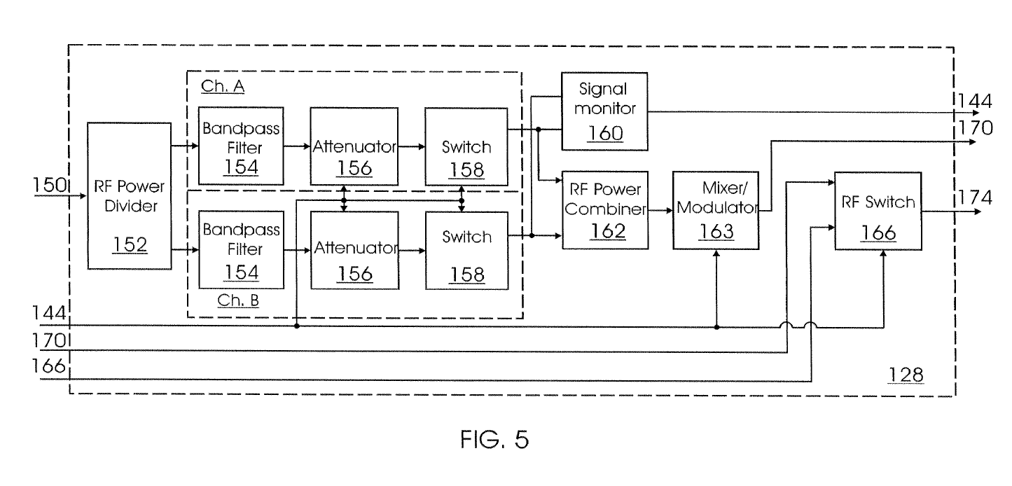

A channel assembly 128 includes a first RF power divider circuit 152 (see FIG. 5) that separates the incoming signals from the RFFE 126 into two or more RF channels (two of which are shown and labeled A and B in FIG. 5), each having a pre-defined RF frequency range. The number of channels and their respective frequency ranges are set by the user during a system set-up operation. The system set-up operation may be performed, for example, by creating a system configuration file on a portable or remote computer, and then down loading the system configuration file to the controller 144 in the system 120.

The channel assembly 128 also includes an RF power combiner circuit 162 (FIG. 5) that produces a single RF output for further processing. Each RF channel A and B includes a band pass filter 154 that defines the specific operating frequency range of the channel; at least one adjustable attenuator 156 for controlling the peak amplitude of the RF signals within the channel; a channel switch 158 that enables or disables the channel; a mixer/modulator circuit 163 that inserts a jamming video signal generated in, and received from the controller 144; and signal monitor 160 that monitors signal activity within the channel. The signal monitor 160 includes a directional detector and an analog-to-digital converter (not shown). The directional detector removes the RF carrier, leaving a video signal that is representative of signal amplitude. The video signal is sent to the controller 144 where it is converted to a digital word. Data provided by the directional detector are used by the controller 144 to calculate the settings of the adjustable attenuators 156 in each channel before the signal is fed to a fiber optic delay line (FODL) assembly 140 (to be described below), which performs optimally only when input signal levels are within a specific range. The settings of the adjustable attenuators 156 may be controlled in accordance with a program, stored in or downloaded to the controller 144, that may take into account a number of operational parameters such as, for example, output signal power capacity, individual channel power capacity, the linearity limits of the FODL assembly 140, the number and amplitudes of active threat signals, and a predetermined threat signal priority.

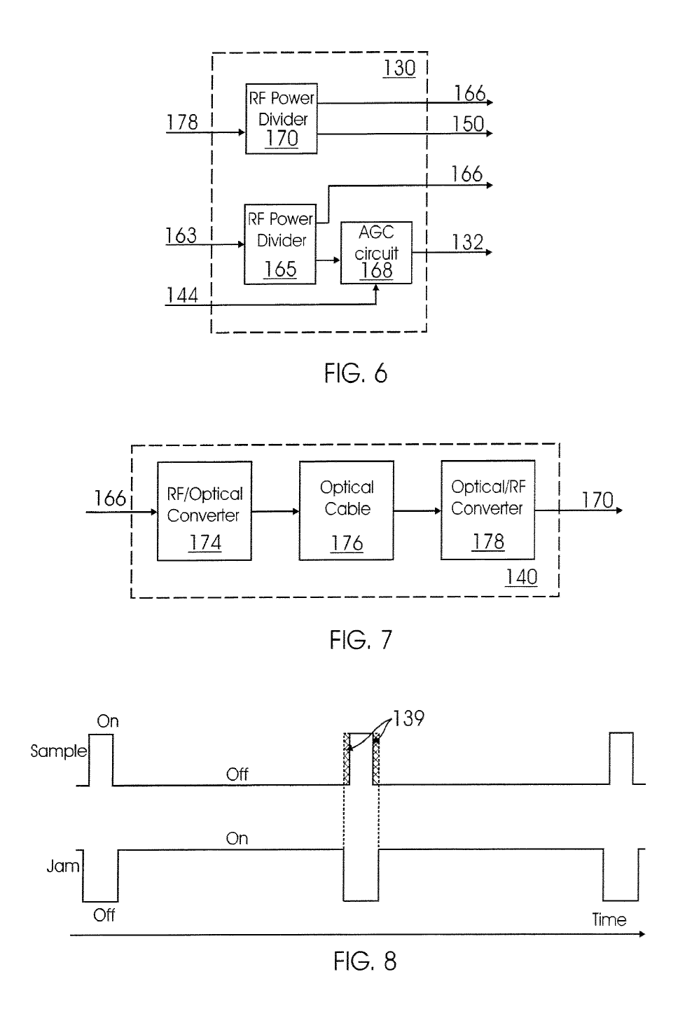

The output signal from the channel assembly 128 is fed to an automatic gain control (AGC) assembly 130 and then to a high power amplifier (HPA) assembly 132, which in a preferred embodiment of the invention, comprises a high-efficiency class AB amplifier having an operational frequency range that encompasses the entire frequency range of the system 120. The AGC assembly 130, illustrated in FIG. 6, substantially inhibits the overdriving of the HPA assembly 132, and it protects the system from damage caused by high-reflected power. As shown in FIGS. 5 and 6, signals arriving from the mixer/modulator 163 in the channel assembly 128 are split into two signal paths by a first AGC RF power divider 165. One path sends the signal to a second RF switch 166 in the channel assembly 128, while the other path sends the signal to the HPA assembly 132 via an automatic gain control circuit 168 that is included in the AGC assembly 130. The automatic gain control circuit 168 prevents a strong signal within any one or more channels from either driving HPA 132 beyond its recommended output power level, causing the generation of unwanted harmonics and spurious signals, or unduly consuming a large amount of the available power for the HPA 132.

A dual directional detector 172, operatively associated with the HPA assembly 132, enables the monitoring of either forward RF power or reverse reflected RF power for AGC purposes. High-reflected power is an indication that a component in the system, such as an element of the antenna assembly 122 a cable, or the T/R switch 124, has failed, or that the antenna assembly 122 has been improperly installed. The controller 144 recognizes the possibility of any of these conditions and directs the HPA 132 to shut down, thus reducing the possibility of permanent damage to the system.

The FODL assembly 140 (FIG. 7) includes an RF-to-optical converter 174, a length of single-mode fiber-optic cable 176 (advantageously provided on a spool, not shown), and an optical-to-RF converter 178. The FODL assembly 140 receives the signal from the second RF switch 166 in the channel assembly 128 (FIG. 5), and it provides an analog RF memory feature that expands a short time sample into a powerful and robust jamming signal by repetitively extracting the contents of the analog RF memory, so that a quasi-CW waveform is created. The length of the fiber-optic cable 176 is determined by the sampling time interval of jammer system 120. For example, a sample time of 25 microseconds requires a fiber-optic cable length of approximately 5.14 km. The fiber-optic cable 176 is ideal for obtaining and repetitively extracting relatively long samples, due to its low insertion loss and time-dispersion characteristics. Other delay line technologies, such as those employing coaxial cables and surface or bulk acoustic-wave devices, are unable to match these performance qualities of the fiber-optic cable.

The output of the optical-to-RF converter 178 is fed back to a second AGC RF power divider 170 in the AGC assembly 130. The second AGC RF power divider 170 divides the signal into a first signal path that is input to the second RF switch 166 in the channel assembly 128, and a second signal path that is input to the first RF switch 150 in the RFFE 126 (FIG. 4).

Referring again to FIG. 3, a global positioning system (GPS) Antenna 134 and a GPS Receiver/Time Reference 136 are used to allow multiple systems 110 to operate without interfering with each other. During normal operation, multi-system synchronization is based on a one-pulse-per-second timing from GPS receiver 136. The look-through period is synchronized with this signal. This signal is used also to compensate for drift in a local time reference, thereby improving the ability to maintain synchronization when there is a loss of GPS signals. Failure to maintain GPS signal lock causes the internal time reference to become the system's timing signal. If necessary, the system can continue operation for over one hour in this clock “flywheeling” mode. The reference in this case is provided by an oven-stabilized, crystal-controlled oscillator (not shown). The time reference reverts to GPS once the GPS time reference signal is re-acquired.

The controller 144 is a microprocessor-based system, located on the system backplane (not shown). The controller 144 performs a variety of functions, including system initialization and configuration, timing, operator interface, diagnostics, maintenance and GPS control. The controller 144 may advantageously include a variety of digital devices, such as a microprocessor, a random access memory (RAM), a read only memory (ROM) and a field programmable gate array (FPGA), as is well-known in the art. The microprocessor provides the decision making capability that is essential for real-time system operation, while the RAM is used to store temporary or changing data. The ROM is used to store operating system and application programs that provide the sequence of steps needed for the system 120 to perform its tasks. The FPGA is configured to generate a video signal that is fed to the mixer/modulator 163 as a jamming signal waveform, as mentioned above. The FPGA is also configured to perform all of the remaining specialized digital processing functions. For example, look-through timing uses a portion of the FPGA that has been configured as a counter to set the sample and transmit times of the system 120. Additional counters are configured within the FPGA to provide control for internal switches (i.e., the T/R switch 124 and the switches in the RFFE 126 and the channel assembly 128) that are related to look-through timing.

The controller 144 is also responsible for performing the calculations associated with the functioning of the AGC assembly 130. This is accomplished by performing analog-to-digital conversions on the video pulse trains from the channel assembly 128 (each channel providing a separate pulse train) and calculating the maximum signal amplitude value emanating from the HPA 132 based on the combined input signal amplitudes plus the gain of the remaining RF path. The calculated maximum signal amplitude value is compared to the peak power capacity of the HPA 132, and the RF path gain is adjusted so that the HPA 132 is not operating in saturation, which could cause excessive signal distortion and possibly unequal sharing of HPA power. Portions of the FPGA are configured to convert the amplitude from the dual directional detector 172 that monitors reverse power within the AGC assembly 130 into its digital equivalent, determines if this amplitude exceeds a specified limit and, if so, generates a sequence of commands to limit or reduce the possibility of damage to the system. Finally, the FPGA contains two serial data ports for controlling the GPS receiver and for providing an operator's interface (not shown).

While operating, the system 120 alternates between Sample Mode and Jam Mode, as shown in the timing diagram of FIG. 8. A guard-band 139 surrounds each of these operation intervals. The guard band 139 is necessary to allow for internal switching, tuning, and other adjustments needed to optimize system performance.

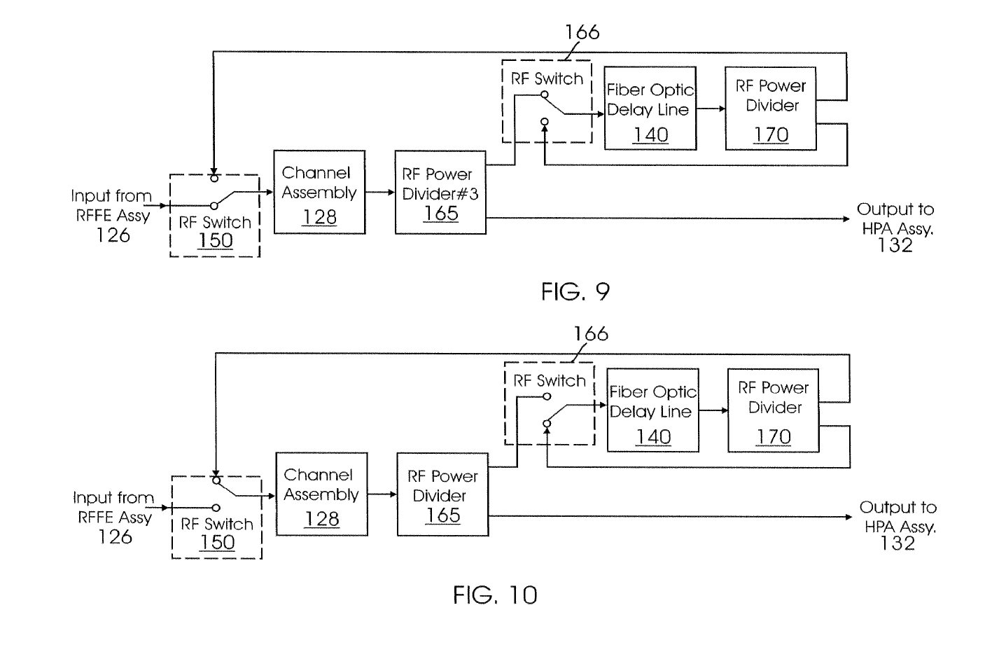

Jamming systems in accordance with the present invention generate jamming waveforms based on a relatively short sample time. FIGS. 9 and 10 respectively show the key internal components within channel assembly 128, the AGC assembly 130, and the FODL assembly 140, in respectively illustrating the sampling and jamming functions of the invention.

As shown in FIG. 9, when the system 120 is in the sampling mode, the first RF Switch 150 is configured to allow the entry of signals from the external electromagnetic environment, via the antenna 122 assembly and the RFFE 126 assembly, into the channel assembly 128. As described previously, the channel assembly 128 performs several signal conditioning processes, including dividing the incoming RF signal into two or more paths, removing unwanted signals that lie outside of a specific channel's operating frequency bandwidth, adjusting the amplitude of the in-range signals, and combining the processed signals of all channels into a single output. This output is then divided into two paths by the first AGC RF power divider 165. One path is connected to the input of the HPA 132 although during the sampling period the HPA 132 output is disabled, so that it does not interfere with the sampling process. The other path encounters the second RF Switch 166, which is configured so that the FODL assembly 140 receives and is filled with the sampled signals. For maximum jamming effectiveness, the length of the cable 176 in the FODL assembly 140 should coincide with the sampling interval. The sampling and delay filling operations occur automatically, regardless of whether weak signals, or even no signals, are present in the sample. Once filled, the sampling process is complete, and the system 120 is automatically reconfigured for jamming.

The filling of the optical fiber cable 176 in the FODL assembly 140 is analogous to a liquid traveling through an empty open-ended pipe. When a sufficient quantity of liquid has entered the pipe, so that it is full, then the liquid begins to spill out on the other end. Similarly, the optical cable 176 of the FODL assembly 140 is also filled when a time sample of sufficient length is entered. Thereafter, the stored sample begins to appear at the delay line output. The output is split into two paths by the second AGC RF power divider 170. The first path re-circulates or feeds the signal back to the FODL assembly 140 through the second RF switch 166, which has changed its configuration so that it no longer inputs the signals from the channel assembly 128 to the FODL assembly 140. In this manner, the contents of the FODL assembly 140 re-enter or re-circulate to the FODL assembly 140 to re-fill the fiber optic cable 176. The re-circulation is performed a predetermined number of times (e.g., 10-20), as determined by the controller 144, before a new RF sample is taken.

The FODL assembly output signals are directed by the second AGC RF power divider 170 to a second signal path that is connected back to the first RF Switch 150, which has changed its configuration, so that external signals are prevented from entering the channel assembly 128. Instead, the first RF switch 150 allows the previously-stored signal to propagate through the channel assembly 128 and the first AGC RF power divider 165 to the HPA assembly 132, which is now enabled. The stored signal (which has been modulated with a jamming video waveform in the channel assembly 128, as described above) is then amplified and radiated to the environment through the antenna assembly 122. Specifically the T/R Switch Assembly 124 is directed by the controller 144 to operate in a transmission mode in which external signals are prevented from entering the system, but in which the output of HPA assembly 132 is sent to the antenna assembly 122 for radiation into the environment.

It can be seen from the foregoing that all signal processing, storage and re-circulation operations are performed at the original RF frequencies of the input signals which may be termed the “baseband” frequencies. Thus, unlike many typical prior art communication and data link jammers, RF frequency conversions are not necessary in the present invention.

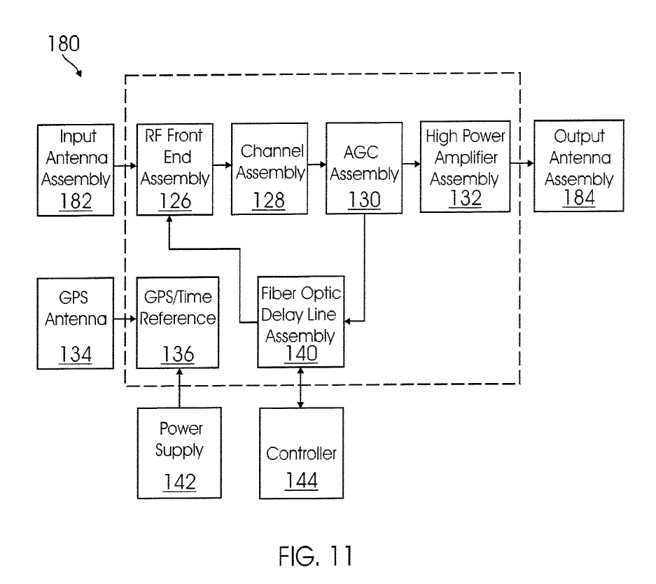

FIG. 11 shows a jammer system 180 in accordance with a second embodiment of the present invention. This implementation provides a separate receiving antenna 182 and transmission antenna 184. While this configuration doubles the number of antenna elements relative to the previously described embodiment, it eliminates the T/R Switch. In some applications, this arrangement may improve operational reliability and decrease manufacturing costs. In addition, the use of separate reception and transmission antennas provides a physical separation that may improve the electromagnetic isolation between input and output assemblies and components. This will often have the effect of reducing the quantity and amplitude of spurious signals within the system, thereby improving the quality of the jamming signal.

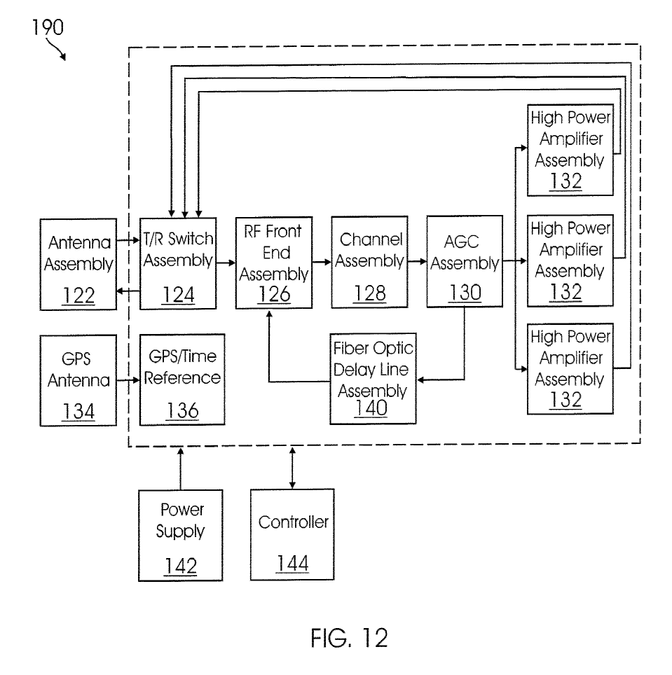

FIG. 12 shows a jammer system 190 in accordance with a third embodiment of the present invention, in which multiple high power amplifier (HPA) assemblies 132 are used (three being shown in the drawing). This embodiment may advantageously be employed when higher output powers are needed to increase jamming effectiveness. In some applications, each of the multiple HPA assemblies 132 may be operated in a narrower bandwidth. In other cases, the operating frequency ranges of the devices being jammed may be so wide that only a single HPA assembly cannot be employed, due to limitations in the power handling capability of its internal components. The use of multiple HPA assemblies may also assist in the disruption of multiple simultaneous threats, whereby the threat signals may be divided among the several amplifiers without exceeding the maximum output power capacity of a single amplifier. Finally, the use of multiple HPA assemblies may result in a lower overall system cost in some applications.

While exemplary embodiments of the invention have been described herein, it is understood that a number of modifications and variations will suggest themselves to those skilled in the pertinent arts. These variations and modifications are may deemed to constitute equivalents to various aspects of the invention described herein, and are considered within the spirit and scope of the invention. Furthermore, the specific software and hardware that may be used to implement various aspects of the invention, as mentioned above, will readily suggest itself to those skilled in the art, and may take any number of equivalent forms that will provide the above-described functional aspects and advantages of the invention.

What is claimed is:

1. A telecommunication countermeasure system, comprising:
an analog RF memory configured to produce a jamming signal from a received signal sample representative of an incident signal;
wherein the jamming signal and the incident signal are characterized by a selected baseband frequency, wherein the received signal sample is received over a predefined sampling interval, and wherein the analog memory is sized to correspond to a predefined sampling interval and to the selected baseband frequency.

2. The telecommunication countermeasure system of claim 1, wherein the received signal sample comprises a plurality of incident signal samples and the analog RF memory is configured to produce a quasi-continuous wave jamming signal from the received signal sample.

3. The telecommunication countermeasure system of claim 1, wherein the incident signal is an RF signal and wherein the analog memory further comprises:
an RF-to-optical converter configured to receive and to convert the received signal sample to an optically-stored signal sample;
a fiber optic delay line coupled to the RF-to-optical converter and sized to correspond to the predefined sampling interval wherein the fiber optic delay line is configured to produce a jamming signal from the optically-stored signal sample; and
an optical-to-RF converter coupled to the fiber optic delay line and configured to convert the optically-stored signal into the jamming signal at the selected baseband frequency.

4. The telecommunications countermeasure system of claim 3, further comprising:
an RF front-end assembly configured to generate the received signal sample from a portion of the incident signal over the predefined sampling interval and coupled to an analog memory input;
an automatic gain control assembly coupled to the analog RF memory and configured to convey the jamming signal for transmission at the selected baseband frequency; and
a controller coupled to the RF front-end assembly and the automatic gain control assembly and configured to selectively control at least one of an incident signal length, the predefined sampling interval, a received sample signal characteristic, and an operating mode, wherein the operating mode includes a sampling operating mode and a jamming operating mode.

5. The telecommunications countermeasure system of claim 4, further comprising a channel assembly having an RF switch coupled between the RF front-end assembly, the automatic gain control assembly, and the controller, wherein the controller causes the switch to select the sampling operating mode or the jamming operating mode.

6. The telecommunications countermeasure system of claim 5, wherein the channel assembly further comprises a signal monitor coupled between the RF front-end assembly and the controller, wherein the controller selectively controls a received sample signal characteristic responsive to an incident signal characteristic signal sensed by the signal monitor.

7. The telecommunications countermeasure system of claim 6, further comprising:
an amplifier assembly coupled to receive the jamming signal from the automatic gain control assembly and configured in the jamming operating mode to amplify the jamming signal into a broadcast jamming signal at the selected baseband frequency; and
a dual directional detector coupled between the amplifier assembly and the automatic gain control assembly, wherein the dual directional detector is configured to detect a reflected RF power corresponding to the broadcast jamming signal.

8. The telecommunications countermeasure system of claim 3, wherein the fiber optic delay line comprises a single-mode fiber optic cable operable at the selected baseband frequency.

9. The telecommunications countermeasure system of claim 6, wherein the signal monitor generates a video signal representative of the incident signal, and wherein the controller is selectively operable in response to the video signal.

10. A telecommunication countermeasure method, comprising:
receiving an incident signal at a selected baseband frequency;
generating a received signal sample from the incident signal at a selected baseband frequency over a predefined sampling interval;
generating a jamming signal from the received signal sample; and
transmitting the jamming signal responsive to the incident signal.

11. The telecommunication countermeasure method of claim 10, further comprising determining the predefined sampling interval in response to the incident signal.

12. The telecommunication countermeasure method of claim 11, further comprising switching between a sampling operating mode and a jamming operating mode, wherein generating the received signal sample and optically generating a jamming signal are performed in a sampling operating mode and wherein transmitting the jamming signal is performed in a jamming operating mode.

13. The telecommunication countermeasure method of claim 12, wherein generating the received signal sample further comprises generating a plurality of incident signal samples from the incident signal and forming therefrom the received signal sample.

14. The telecommunication countermeasure method of claim 13, wherein optically generating a jamming signal further comprises generating a quasi-continuous wave jamming signal from the received signal sample.

15. The telecommunication countermeasure method of claim 12, wherein transmitting the jamming signal further comprises amplifying the jamming signal into a broadcast jamming signal and transmitting the broadcast jamming signal.

16. The telecommunication countermeasure method of claim 14, wherein transmitting the jamming signal further comprises amplifying the jamming signal into a broadcast jamming signal and transmitting the broadcast jamming signal.

17. A radio frequency (RF) jamming system, comprising:
an RF front-end assembly configured to generate a received signal sample from an incident signal at a selected baseband frequency over a predefined sampling interval;
a fiber optic delay line assembly coupled to the RF front-end assembly and configured to store a jamming signal at the selected baseband frequency;
an automatic gain control assembly coupled to the fiber optic delay line assembly and configured to convey at least a portion of the stored jamming signal for transmission at the selected baseband frequency;
a controller coupled to the RF front-end assembly and to the automatic gain control assembly, and configured to selectively control at least one of an incident signal length, the predefined sampling interval, a received sample signal characteristic, and an operating mode;
an RF switch coupled between the RF front-end assembly, the automatic gain control assembly, and the controller, wherein the operating mode includes a sampling operating mode and a jamming operating mode, and wherein the controller causes the RF switch to select the sampling operating mode or the jamming operating mode; and
an amplifier assembly coupled to receive the jamming signal from the automatic gain control and to amplify the stored jamming signal into a broadcast jamming signal for transmission at the selected baseband frequency;
wherein the stored jamming signal is generated in the sampling operating mode and the broadcast jamming signal is transmitted in the jamming operating mode.

18. The RF jamming system of claim 17, wherein the fiber optic delay line assembly further comprises:
an RF-to-optical converter configured to receive and to convert the received signal sample to an optically-stored signal sample;
a fiber optic delay line coupled to the RF-to-optical converter and sized to correspond to the predefined sampling interval, wherein the fiber optic delay line is a single-mode fiber optic cable configured to produce the stored jamming signal from the optically-stored signal sample; and
an optical-to-RF converter coupled to the fiber optic delay line and configured to convert the stored jamming signal into the broadcast jamming signal at the selected baseband frequency.

19. The RF jamming system of claim 18, wherein the channel assembly further comprises a signal monitor coupled between the RF front-end assembly and the controller, wherein the controller selectively controls a received sample signal characteristic responsive to an incident signal characteristic signal sensed by the signal monitor.

20. The RF jamming system of claim 19, further comprising a dual directional detector coupled between the amplifier assembly and the automatic gain control assembly, wherein the dual directional detector is configured to detect a reflected RF power corresponding to the broadcast jamming signal.

21. A system for jamming an external RF signal, comprising:
a video signal generator that generates a video jamming signal
a channel assembly configured to receive an external RF signal and the video jamming signal;
a modulator in the channel assembly configured to modulate the external RF signal with the video jamming signal to create a modulated RF jamming signal;
a signal storage element, comprising a delay line, configured to receive the jamming signal from the modulator and to re-circulate the jamming signal to the channel assembly a predetermined number of times; and
an output assembly, comprising an amplifier and an antenna, that receives the jamming signal from the channel assembly after the predetermined number of re-circulations and that transmits the jamming signal so as to jam the external RF signal.

22. The system of claim 21, wherein the delay line includes a fiber-optic cable.
